(19) United States
(12) Patent Application Publication
(10) Pub. No.: US 2026/0153398 A1
(43) Pub. Date: Jun. 4, 2026

(54) Method for Calibrating a Measuring Device of a Wind Turbine

(71) Applicant: Wobben Properties GmbH, Aurich (DE)

(72) Inventors: Ulf Schaper, Staffhorst (DE); Frank Bunge, Ludwigshafen (DE); Georg Eden, Westerholt (DE)

(73) Assignee: Wobben Properties GmbH, Aurich (DE)

(21) Appl. No.: 19/171,851

(22) Filed: Apr. 7, 2025

(30) Foreign Application Priority Data
Apr. 11, 2024 (EP) 24169659.0

(51) Int. Cl. G01L 25/00; F03D 17/00

(52) U.S. Cl. CPC G01L 25/00; F03D 17/011; F03D 17/028; F05B 2260/83

(57) ABSTRACT

A method for calibrating a measuring device for measuring the load on a rotor blade of a wind power installation is disclosed. At least one conversion factor for converting a detected sensor value of a load sensor into a load value acting on the rotor blade is determined for each rotor blade, a sensor value is recorded by the load sensor, and the conversion factor is determined from a relationship between a load value and a load value acting on the rotor blade A sensor value is recorded by the load sensor, and the conversion factor is calculated from a relationship between the sensor value and the comparative force acting on the rotor blade. The comparative force is calculated based on a weight force acting on the rotor blade, and is determined based on a deviation between the comparative force and the weight force.

### TECHNICAL FIELD

The present disclosure relates to a method for calibrating a measuring device for measuring the load of a rotor blade of a wind power installation. The disclosure also relates to a corresponding device for carrying out such a calibration method.

### BACKGROUND

Wind power installations generate electrical power from wind and usually have a rotor with several, in particular three, rotor blades. The rotor blades experience corresponding forces from the wind, which can damage the rotor blades or reduce the service life of the rotor blades if they are too large and/or have large values too often. A blade impact load or a corresponding impact moment acting on one rotor blade at a time can be of particular importance.

### SUMMARY

In order to detect loads or rotor blades, appropriate load sensors can be provided on the rotor blades, for instance, in the area of their blade roots.

Blade loads on rotor blades are usually measured indirectly via material strain. For this purpose, measuring devices are used that record small-scale strains, e.g., strain gauges or fiber optic cables with a fiber Bragg grating. The blade loads are determined from these measurements by offset correction and multiplication by a calibration factor (amplification factor). The calibration factor contains (among other things) the ratio assumed to be constant between the small-scale strains at the measuring point and the large-scale rotor blade load (e.g., blade root bending moment). The calibration factor is usually determined in a situation in which the acting rotor blade load is known, so that the calibration factor is determined by dividing the known rotor blade load and the local strain then detected. If the local strain is not measured directly, but a measured variable such as the differential voltage of a strain gauge measuring bridge or the wavelength shift of a fiber Bragg grating, the calibration factor can also take these effects of the measuring system into account.

The rotor blade load assumed to be known during the calibration procedure is usually the gravitational load, i.e., it is determined from the component mass and component position in space assumed to be known. Inertial forces and other forces acting on the component, such as aerodynamics, are disregarded. The calibration factor can also be referred to synonymously as a conversion factor.

The calibration factor or conversion factor thus creates a relationship between the output signal of the sensor and the assigned load value, i.e., the load torque. In simplified terms, such a relationship can be derived from the weight force on the relevant rotor blade when there is no wind and the rotor is stationary. The weight force or the load moment acting due to the geometry and weight distribution of the rotor in question are known because the geometry of the rotor blade, including its weights, is known. A load torque resulting from the weight force can therefore be determined (e.g., when the rotor blade in question is in a horizontal position), and a correlation can then be formed with the sensor signal present at that moment.

However, it has been shown that it can be advantageous to calibrate not only when the system is stationary, but also when it is rotating. In particular, this enables a more dynamic calibration and also a repetition of the calibration. It can be advantageous to repeat the calibration regularly. If the calibration is also carried out at high wind speeds, especially in strong winds, large errors can occur due to the influence of the wind, because such aerodynamic influences can then no longer be disregarded.

The present disclosure is directed to addressing at least one of the aforementioned problems. For example, a solution is proposed in which a calibration can also be carried out outside of calm conditions or can be carried out with improved accuracy in strong winds compared to the prior art.

According to the present disclosure, a method according to claim 1 is proposed. Such a method relates to the calibration of a measuring device for measuring the load of a rotor blade of a wind power installation. Such a wind power installation has a rotor with a rotor axis and a plurality of rotor blades of which the blade angle can be adjusted. Typically, three rotor blades are provided, which substantially form this rotor and rotate around the rotor axis during operation.

In another aspect, at least one conversion factor is determined for converting a detected sensor value of a load sensor into a load value acting on the rotor blade, such as in the area of its blade root, for each rotor blade for calibration. Such a conversion factor can also be referred to synonymously as a calibration factor or amplification factor.

Such a conversion factor is therefore a proportional value that establishes proportionality between the sensor value and the load value. A sensor that detects strain, as explained above, and outputs the sensor value proportional to the strain can be used as a sensor. However, an offset can also be added, which performs an offset correction for the sensor value. In this respect, the conversion factor can be part of a conversion function. In the simplest case, however, it is also possible that only the conversion factor is present, wherein the offset correction is usually present. However, there can also be a conversion function that can have several conversion factors. However, one conversion factor is often sufficient.

In one aspect, a sensor value is recorded by the load sensor in a detection step. The conversion factor is then produced from a relationship between the sensor value, which was detected in the detection step, and a comparative force. The comparative force is the force that acts on the rotor blade in the detection step and is known or can be calculated.

In this respect, the comparative force is calculated as a function of a weight force acting on the rotor blade. The calculation can be carried out, for example, by multiplying a mass of the rotor blade by the acceleration due to gravity g and the distance between a center of gravity of the rotor blade and the blade root or the blade root area in which the load sensor is located. The comparative force can be understood as a force similar to the weight force and can ideally correspond to it. However, it is proposed that the comparative force should also be determined as a function of a correction component that takes into account a deviation between the comparative force and weight force. In this respect, the comparative force and the weight force are therefore not identical.

In one aspect, the method may be used when there is wind and the rotor is turning, especially at high wind speeds. This means that calibration is also possible at high wind speeds and there is no need to wait for calm conditions or situations with little wind to determine the conversion factor. If the conversion factor is determined when there is a lot of wind, it could be falsified and corrected with the correction component. This correction component depends on the wind. However, the method can also be used when there is no wind. In this case, the correction component can be 0, or 1 if it is applied multiplicatively.

According to aspects of the present disclosure, a correction component is determined and taken it into account accordingly, thereby improving the comparative force compared to the weight force. The calibration is then calculated based on the sensor value recorded in the detection step and the improved comparative force as described.

According to one aspect, the correction component is determined as a function of an aerodynamic force acting on the rotor blade and/or is determined as a function of an axial inclination of the rotor axis. The correction component may be taken into account as a function of an aerodynamic, upwardly directed force which is caused by wind and exerts a lift on the rotor blade due to the axial inclination of the rotor.

An aerodynamic force can occur, which acts on the rotor blade in such a way that it reduces the effect of the weight force. This can be explained for horizontally positioned rotor blades, although the force is not limited to horizontal rotor blades. With horizontally positioned rotor blades, i.e., in the 9 o'clock position and 3 o'clock position of the rotor, in relation to the rotor blade in question, a force from the wind can flow against the rotor blade from below, so to speak, thereby reducing the weight force.

It should be noted that this aerodynamic force is in the opposite direction to the weight force in the 9 o'clock position of the rotor blade and in the 3 o'clock position of the rotor blade. This is unusual in that aerodynamic forces on the rotor blades of a rotor are usually related to the direction of rotation of the rotor, as they usually result from the profile of the rotor blade, which is designed to result in a force to turn the rotor. To put it simply, such a force would normally be directed upwards on a rotor blade in the 9 o'clock position and downwards on the same rotor blade in the 3 o'clock position, or vice versa. However, the fact that it is directed upwards in both cases, i.e., for the 9 o'clock position and the 3 o'clock position, has been recognized here and taken into account in order to adjust or correct the comparative force in relation to the gravitational force accordingly.

For example, such an aerodynamic force from the wind, which is opposed to the gravitational force, can arise due to an axial inclination of the rotor axis. This force can arise if the rotor axis is inclined, namely in such a way that the rotor in the tower area is inclined away from the tower. To illustrate this, a horizontal wind nevertheless flows against the rotor blades from below due to the axial inclination of the rotor.

Such forces can be detected in simulations or comparative tests of a representative wind power installation.

According to one aspect, it is proposed that the calibration is carried out completely or partially during running operation of the wind power installation and/or is carried out in a protective mode in which the rotor blades are in a protective mode position that deviates by a maximum of 30° from a vane position. For example, it is proposed that the detection step is carried out during running operation or in protective mode of the wind power installation.

In one example, the method is not only be carried out when there is no wind or very little wind. This means that the calibration is not limited to such rare situations, but can be carried out more frequently. It is also possible to carry out a calibration before and after a period of strong wind in order to take possible changes into account. Especially before a strong wind period or strong wind situation, it is important that the calibration is as accurate and error-free as possible and adapted to any changes that may have occurred in order to correctly detect strong loads in the strong wind period or strong wind situation.

For example, in strong winds, it is possible that the wind power installation is operating in a protective mode or is at least in such a mode in which the rotor blades are in the protective mode position to protect the wind power installation. Such a protective operating position can be close to a vane position, but differs from it. Preferably, it differs by at least 5° from the vane position, which is approximately 90°. This position of the rotor blades, which is similar to the vane position, ensures that little load from the wind is placed on the rotor blades, although some lift from the wind acts on the rotor blades so that the rotor can turn slightly. This allows the rotor blades to assume different positions and therefore also positions in which calibration can be carried out. Such positions can be those in which the rotor blades are substantially horizontal. A substantially horizontal position is one that deviates from a horizontal position by up to +/−30°, up to +/−20°, etc., For example, a substantially horizontal position deviates by the stated values from a 9 o'clock position or 3 o'clock position of the rotor in relation to the respective rotor blade.

In one example, calibration is carried out completely during running operation or in the protective mode described. However, it is also possible, for example, for calibration to be carried out only partially during running operation or in protective mode to the extent that the detection step is carried out during running operation or in protective mode. The calculation can also take place later, for example, and does not have to be carried out during running operation or protective mode. However, it is also expedient to carry out the calculation during running operation or protective mode.

According to one aspect, it is proposed that the calibration (e.g., the detection step), is carried out at least partially at high wind speeds, above a nominal wind speed, for example, above a storm wind speed, at which operation of the installation is reduced to protect the wind power installation.

Calibration, at least the detection step, is therefore carried out at least partially at high wind speeds and is therefore not limited to partial load operation or to a standstill of the wind power installation. A nominal wind speed is already a high wind speed, as the wind power installation's operation is limited to nominal speed and nominal power above this speed. However, calibration at even higher wind speeds, above a storm wind speed, is also suggested. This means that calibration can also be carried out at high wind speeds and changes affecting the calibration can be taken into account quickly.

A storm wind speed is one at which the wind power installation was historically switched off in order to protect it. Modern wind power installations are still based on such a storm wind speed, which can be 20 to 25 m/s, for example, but do not switch off the wind power installation, but reduce operation of the installation by reducing the speed and power of the wind power installation, namely below the nominal speed or below the nominal power.

Furthermore or alternatively, it is proposed that the calibration (e.g., the detection step), is carried out at least partially at an approximately horizontal position of the rotor blade or approximately at a 9 o'clock or 3 o'clock position of the rotor, relative to the rotor blade. The advantages of this have already been described above and detection can best be carried out at a 9 o'clock or 3 o'clock position. If the position of the rotor blade deviates slightly from this, a good detection or good calibration can still be carried out. Such a deviation can be up to 30°, up to 20°, etc., and then reference can still be made to a position that is approximately horizontal.

Such approximately horizontal positions of the rotor blade can also occur during running operation and also at high wind speeds above the nominal wind speed and also above the storm wind speed and can be used for calibration.

It is important that at such high wind speeds, errors due to aerodynamic influences are corrected or factored out, as proposed in accordance with the present disclosure. If a correction component is taken into account in this way, the advantages of the calibration can also be used at high wind speeds, while problems caused by the high wind speeds are eliminated or at least reduced.

According to one aspect, it is proposed that the correction component is determined by a simulation and/or by comparative measurements. The correction component can take into account complex aerodynamic relationships, so that its determination can also be complex. The use of a simulation is therefore proposed. The correction component depends on the shape and position of the rotor blade, including the inclination of the rotor axis. However, all these data are known and can therefore be taken into account in a simulation. For example, different situations such as wind situations, positions of the rotor and rotor blade in relation to the blade angle can be taken into account. For this purpose, a simulation of the behavior of the wind power installation can be carried out and the results stored in a table, which can then be called up for calibration. Intermediate values can be taken into account by interpolation.

Comparative measurements can also be carried out in a similar way. Here, instead of a simulation, or in addition to it, load measurements can be carried out with additional load sensors and/or other recording of blade loads. Such comparative measurements can be carried out with a wind power installation of the same type as the wind power installation for which the calibration is to be carried out. The comparative measurements therefore do not have to be carried out with the same wind power installation. Correction components determined by comparative measurements can also be stored in a table together with the respective boundary conditions. The correction components can then be retrieved from the table for the same boundary conditions and intermediate values can be interpolated.

In one example, this involves a correction component that takes into account a systematic influence that changes the effect of the weight force on the rotor blade, for example, by factoring it out. In some aspects, this involves a force that counteracts the weight force, both at the 9 o'clock position and the 3 o'clock position, or similar values. In some aspects, it is a matter of such a correction component, which cannot be factored out specifically by the fact that it occurs in the opposite direction at the 9 o'clock position and the 3 o'clock position. It therefore has a systematic influence in that it always counteracts the weight force (e.g., at the two positions of 9 o'clock and 3 o'clock), stated by way of example.

In addition or alternatively, it is proposed that the correction component is determined as a function of the blade angle of the rotor blade. It was recognized here that this blade angle can have a significant influence on the distortion and can therefore be taken into account by the correction component. Such a blade angle can also be taken into account for the simulation or the comparative measurements and it can be taken into account as a boundary condition and stored in a table.

According to one aspect, it is proposed that the recording of a sensor value in the detection step and the calculation of the conversion factor from a relationship between the detected sensor value and the comparative force is repeated at the same wind speed and/or the same rotor speed and/or the same rotor blade angle. It is also proposed that an overall conversion factor is determined from the individual conversion factors calculated during each repetition, as the mean value of the individual conversion factors.

It is recognized here that an equal correction component can be assumed for the same wind speed and/or the same rotor speed. In some aspects, the rotor speed can be representative of a wind speed, at least as long as the wind speed is below a nominal wind speed. At wind speeds above the nominal wind speed, such as above a storm wind speed, i.e., in strong winds, the wind power installation can be set to a calibration mode for calibration, in which the rotor blades are in the protective operating position, i.e., in a position that deviates from the vane position by a maximum of 30°, so that the rotor only turns slightly due to the wind. Even in such a position or situation, the rotor speed can be assumed to be proportional to the wind speed.

In this respect, the same rotor speed indicates the same wind conditions.

Therefore, if the same wind speed can be assumed based on the indicators, or because the same wind speed was detected, an equal correction component can be assumed so that a conversion factor can be determined repeatedly under the same conditions and an overall conversion factor can be determined from these, by averaging. This can increase the accuracy of a total conversion factor determined in this way. Instead of or in addition to averaging, it is also possible, for example, to eliminate one or more of the many calculated conversion factors that deviate too much from the others.

According to one aspect, it is proposed that
the recording of a sensor value in the detection step and the calculation of the conversion factor from a relationship between the detected sensor value and the comparison force is repeated at regular intervals, such as within 1-7 days, 1-4 weeks and/or 1-12 months, and
the respective calculated conversion factors are stored, together with the respective associated boundary conditions.

Such boundary conditions can be the wind speed and/or the rotor speed.

In some aspects, the conversion factors can change and therefore a regular redetermination and thus updated calibration is advantageous. The fact that the proposed method also enables good determination of the conversion factor at high wind speeds means that such regular recalibration can be carried out. It may not be necessary to wait until the wind speed is low.

In general, it has been recognized that the wind power installation should always be calibrated directly after its installation, i.e., regardless of the current wind conditions. This is made possible by the proposed method.

It has also been recognized that the material, namely the rotor blade and the load sensor, can be influenced by temperature or other changes can occur, e.g., due to fatigue. The material properties can therefore change continuously. Frequent calibration means that the sensor values can be determined correctly again. Such frequent calibration is therefore suggested and also enables the conversion factor to be determined even at high wind speeds.

In principle, it may not be necessary to save the conversion factors, as only the current conversion factor is required in each case. However, it was recognized that by storing the conversion factors, it is possible to compare several conversion factors recorded at different times and/or under different boundary conditions, in order to detect errors and/or material changes in the respective load sensor and/or rotor blade.

According to one aspect, it is proposed that the rotor speed is incorporated quadratically into the correction component, together with a weighting factor.

In addition or as an alternative, it is proposed that the calibration be carried out without generator torque. The generator is therefore not activated.

It is based on the knowledge that the correction component factors out an aerodynamic force acting on the rotor blade from the wind. This aerodynamic force can depend on the square of the wind speed and the rotor speed can be proportional to the wind speed. This can be the case if there is no generator torque, i.e., the generator is idling. The correction component can then be assumed to be quadratic to the rotor speed. This is true in part-load operation, in which a constant speed is assumed, which results in the proportionality between rotor speed and wind speed. However, it also applies in the calibration mode, in which the rotor blades are in the protective operating position at high wind speeds, such as in strong winds, i.e., in a position that deviates from the vane position by a maximum of 30°, so that the rotor only turns slightly due to the wind. Here too, a rotor speed proportional to the wind speed can be assumed.

According to one aspect, it is proposed that
the correction component is determined as an additive correction value, so that the conversion factor is calculated from a sum of the weight force and the correction component, such that the conversion factor U is calculated according to the equation

$$U = S / ( G - {W}_{1} * {n}^{2} )$$

with
   S: sensor value,
   G: weight force acting on the rotor blade
   W₁: first weighting factor for additive correction value and
   n: rotor speed or wind speed, wherein
the term W₁*n² represents the additive correction value and the term (G−W₁*n²) represents the comparative force.

Alternatively, it is proposed that
the correction component is determined as a multiplicative correction value, so that the conversion factor is calculated from a product of the weight force and the correction component, such that the conversion factor U is calculated according to the equation

$$U = S / ( G * ( 1 - {W}_{2} * {n}^{2 )} )$$

with
   S: sensor value,
   G: weight force acting on the rotor blade
   W₂: second weighting factor for multiplicative correction value and
   n: rotor speed or wind speed, wherein
the term (1−W₂*n²) represents the multiplicative correction value and the term G*(1−W₂*n²) represents the comparative force.

It was recognized here that the correction component can be determined as an additive correction value or as a multiplicative correction value and can then also be applied accordingly. A specific formula is proposed for both variants. In both cases, the rotor speed is included quadratically in the correction value, both in the additive and the multiplicative correction value. This is also based on the idea that the wind speed is incorporated quadratically into the force that the correction value is intended to correct. A proportionality between the rotational speed and wind speed is also assumed here. In this respect, the method is also preferably carried out in partial load operation or calibration mode.

The use of this calculation, in which the speed is incorporated quadratically into the correction value, is therefore not limited to carrying out the method in partial load operation. It can also be used when the rotor speed is only low at very high wind speeds because the rotor blades have assumed a vane position or a position similar to the vane position with regard to their rotor blade angles. Even then, the resulting low rotor speed can be roughly proportional to the wind speed.

A detected or estimated wind speed can be used instead of the rotational speed. In the formulas, the wind speed would then be used for the variable n instead of the rotor speed. The variable v_{W} can also be used for the wind speed and inserted instead of the variable n. The adapted formulas are then, instead of U=S/(G−W₁*n²) or U=S/(G*(1−W₂*n²)), with v_{W} used for n, U=S/(G−W₁*v_{W}²) or U=S/(G*(1−W₂*v_{W}²)). Of course, this will result in different values and units for the weighting factors.

According to aspects of the present disclosure, a wind power installation is also proposed which is prepared for carrying out a method for calibrating a measuring device for measuring the load of a rotor blade of the wind power installation, wherein the wind power installation has a rotor with a rotor axis and a plurality of rotor blades which can be adjusted in their blade angle, and the method is wherein
for one rotor blade at a time,
at least one conversion factor for converting a detected sensor value of a load sensor into a load value acting on the rotor blade, such as in the area of its blade root, is determined for calibration,
a sensor value is recorded by the load sensor in a detection step, and
the conversion factor is calculated from a relationship between the sensor value detected in the detection step and the comparative force acting on the rotor blade, wherein
the comparative force is calculated as a function of a weight force acting on the rotor blade, and
the comparative force is additionally determined as a function of a correction component that takes into account a deviation between the comparative force and the weight force.

Such a wind power installation is therefore prepared to carry out a calibration method as explained above. In some aspects, the method can be implemented as a computer program on a process computer.

According to one aspect, it is proposed that the wind power installation has a control device for controlling the wind power installation and/or the wind power installation. In one example, the control device is prepared to carry out a method according to one of the aspects described above.

Such a control device can control the wind power installation and carry out activities such as setting a power output, realizing azimuth tracking and, in some examples, adjusting the rotor blade angles. Such a control device is generally known and is basically present in wind power installations. Such a control device is also provided here. It can include the aforementioned process computer or the process computer can form the control device.

The wind power installation is prepared to implement the calibration method. For this purpose, the corresponding method can be implemented on the wind power installation and in some examples can be implemented in the control device. In this respect, the control device then differs from conventional control devices due to the implemented method. For example, the control device can receive values from the load sensors and can implement calculation rules for calculating a weight force. For this purpose, it can receive corresponding data from the rotor blade or has already received it as fixed data during commissioning. To calculate the conversion factor, the blade position can then be taken into account in terms of the rotor position and optionally also the rotor blade angle of the relevant rotor blade.

The method can then be implemented in the control device based on these values. However, the control device can also be designed as a control device consisting of elements distributed locally across the wind power installation, i.e., partial control units.

### BRIEF DESCRIPTION OF THE DRAWINGS

The disclosure is explained in more detail below by way of example with reference to the accompanying figures.

FIG. 1 shows a wind power installation in a perspective view.

FIGS. 2A and 2B schematically show two rotor positions for calibrating a measuring device for load measurement.

FIG. 3 schematically shows a wind power installation to explain an axial inclination.

FIGS. 4A and 4B schematically show a part of a wind power installation to illustrate different aerodynamic forces on a rotor blade as a function of an axial inclination.

FIG. 5 schematically shows a measuring device for load measurement of a rotor blade.

### DETAILED DESCRIPTION

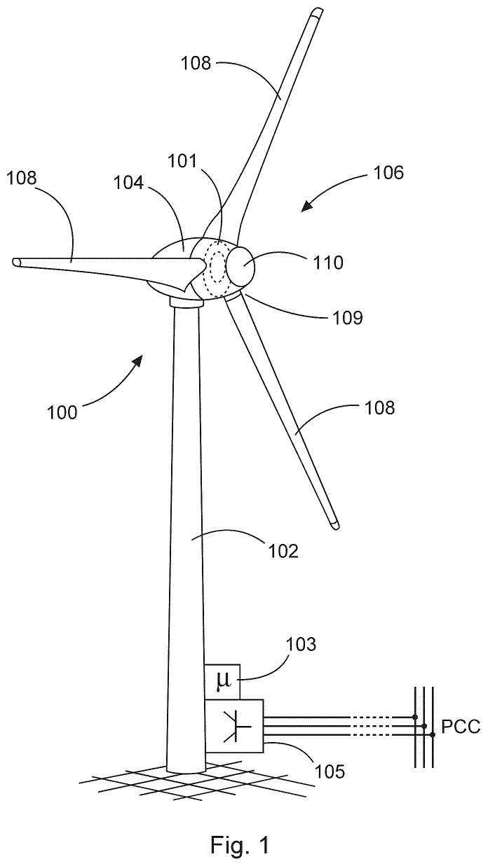

FIG. 1 shows a schematic representation of a wind power installation according to aspects of the present disclosure. The wind power installation 100 has a tower 102 and a nacelle 104 on the tower 102. An aerodynamic rotor 106 with three rotor blades 108 and a spinner 110 is provided on the nacelle 104. During operation of the wind power installation, the aerodynamic rotor 106 is set in rotation by the wind and thus also rotates an electrodynamic rotor or rotor of a generator, which is coupled directly or indirectly to the aerodynamic rotor 106. The electrical generator is arranged in the nacelle 104 and generates electrical energy. The pitch angles of the rotor blades 108 can be changed by pitch motors on the rotor blade roots 109 of the respective rotor blades 108.

The wind power installation 100 has an electric generator 101, which is indicated in the nacelle 104. Electrical power can be generated by means of the generator 101. A feed-in unit 105, which can be designed as an inverter, is provided for feeding in electrical power. This can be used to generate a three-phase feed-in current and/or a three-phase feed-in voltage according to amplitude, frequency and phase, for feeding in at a grid connection point PCC. This can be done directly or together with other wind power installations in a wind farm. An installation controller 103 is provided to control the wind power installation 100 and also the feed-in unit 105. The installation controller 103 can also receive default values from an external source, such as from a central wind farm computer. The installation controller 103 is an example of a control device for controlling the wind power installation.

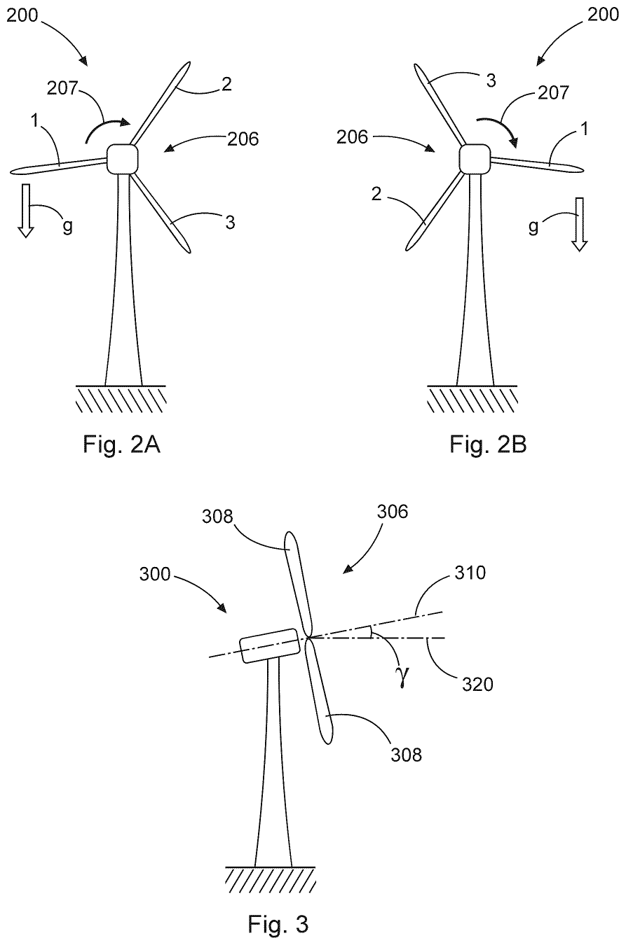

FIGS. 2A and 2B schematically show a wind power installation 200 with three rotor blades 1, 2 and 3. For the purposes of explanation, the rotor blade 1 is considered here. In relation to this rotor blade 1, the rotor 200 has a 9 o'clock position in FIG. 2A and a 3 o'clock position in FIG. 2B. Accordingly, the gravity or acceleration due to gravity g is indicated as it acts on this rotor blade 1. The figures also show a direction of rotation 207 of the rotor 206. It is clear from this that at the 9 o'clock position of FIG. 2A, the gravity or acceleration due to gravity g counteracts the direction of rotation 207. On the other hand, the gravity or acceleration due to gravity g acts in the same direction as the direction of rotation 207 when the rotor blade 1 is in the 3 o'clock position, as FIG. 2B shows.

This shows that forces that always act in the direction of rotation can be factored out in that they counteract gravity or acceleration due to gravity in the 9 o'clock position and increase it in the 3 o'clock position. These different directions can be factored out if corresponding comparative measurements are taken in the 9 o'clock position and the 3 o'clock position. However, it has been recognized that aerodynamic forces can also occur which counteract gravity or acceleration due to gravity in both positions, or which may amplify them in both cases. Such forces are to be determined and factored out.

Such forces can occur due to an axial inclination of the rotor axis, which has become greater nowadays compared to the past due to the lighter design of the rotor blades and also ever longer rotor blades. FIG. 3 shows such an axial inclination with an inclination angle γ.

To this end, a wind power installation 300 with a rotor 306 with rotor blades 308 is shown schematically in FIG. 3. The wind power installation 300 should also have three rotor blades 308, but this cannot be seen exactly in the schematic representation of FIG. 3.

In any case, the wind power installation 300 or its rotor 306 has a rotor axis 310, and this is inclined relative to a horizontal 320 by the angle of inclination γ.

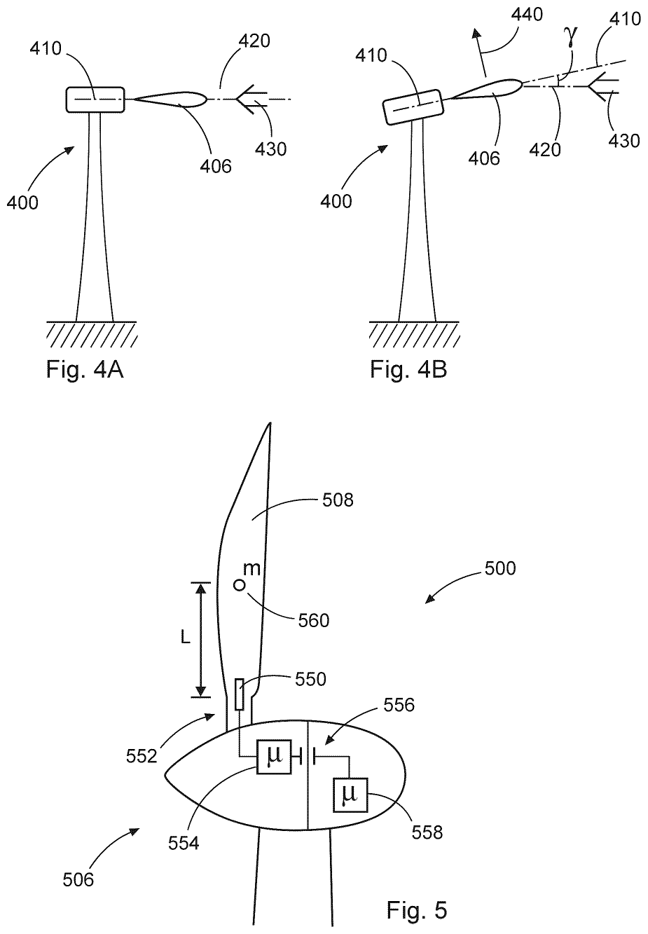

The effects resulting from the inclination angle are explained in FIGS. 4A and 4B. For this purpose, both figures show a schematic representation of a wind power installation 400, of which only one rotor blade 406 is shown for illustration purposes. For better comparability, the same reference signs are used in FIGS. 4A and 4B, although both wind power installations 400 differ in an inclination angle γ between FIGS. 4A and 4B.

The wind power installation 400 in FIG. 4A has no angle of inclination and is therefore intended to serve as a comparative wind power installation. Here, the wind flows horizontally with a wind direction 430, i.e., parallel to a horizontal 420. The rotor axis 410 also runs horizontally, so that the horizontally flowing wind with the wind direction 430 does not lead to any additional lift on the rotor blade 406.

However, according to FIG. 4B, the rotor axis 410 has an angle of inclination γ relative to the horizontal 420. Here, the wind flows onto the rotor blade with the same wind direction 430, but this leads to a lift 440 of the rotor blade due to the angle of inclination γ of the rotor axis 410. This lift is always directed upwards, regardless of whether the rotor is in a 9 o'clock position or a 3 o'clock position in relation to the rotor blade in question.

FIG. 5 illustrates a wind power installation 500 with a rotor 506 with rotor blades 508, of which only one is shown in FIG. 5. However, all other rotor blades are constructed like the one shown in FIG. 5.

To detect loads, a load sensor 550 is provided, which is arranged in an area of the blade root 552. The load sensor 550 can be designed as a strain gauge, to name just one example. Other examples have already been mentioned above. The load sensor detects a strain of the rotor blade 508 in the area in which it is arranged. For this purpose, the load sensor transmits a respective sensor value to the sensor processor 554, which transmits it via a transformer 556, which can be designed as a slip ring transformer, to a computing unit 558. The conversion factor can be implemented in the computing unit 558 in order to determine a blade load from the sensor value. The blade load is therefore a load value that was determined using the load sensor and the conversion factor. The load sensor 550 with the sensor processor 554 and the computing unit 558 can form the measuring device for measuring the load on the rotor blade. The transformer 556 may be considered part of the measuring device. The computing unit 558 may be part of a control device.

For calibration purposes, a comparative force can be determined from a weight force. Due to the acceleration due to gravity g, a blade root bending moment acts in the area of the load sensor 550, which can be calculated as m*g*L if the rotor is in a 9 o'clock position in relation to the relevant rotor blade. The same blade root bending moment, but with a negative sign, results at a 3 o'clock position. Here, g is the acceleration due to gravity, m is the mass of the rotor blade and L is the distance from the position of the load sensor 550 to the center of gravity 560.

The present disclosure, which has also been exemplified with reference to the figures above, at least partially compensates for calibration errors in situations in which typical aerodynamic forces from strong wind situations occur. The disclosure thus relates to the calibration of load measurements on wind power installations and enables calibration outside of calm conditions or improves accuracy in strong winds.

When considering the influence of aerodynamic forces, it is suggested to take into account the fact that aerodynamic forces can increase quadratically with the wind speed. It is also proposed to take into account that with a constant blade angle and without counter torque, the rotor speed is proportional to the wind speed.

The measurement of the blade root bending moment is usually calibrated in situations in which the rotor blade is pointing sideways away from the turbine, as FIGS. 2A and 2B illustrate.

The following preferred positions or options can be considered as rotor positions in relation to a rotor blade to be calibrated:
the “9 o'clock position”, in which the blade root bending moment can be calculated as +m*g*L.
the “3 o'clock position”, in which the blade root bending moment can be calculated as −m*g*L,
other rotor configurations, in which the blade root bending moment can be calculated as m*g*L*sin(β) if β is the rotor angle for the rotor blade in question,
a combination of several rotor positions, up to an integral of all values over one or more rotor revolutions, in which an integral is formed over the absolute values of m*g*L*sin(β) over the rotor angle.

Especially when evaluating several rotor positions, it is advisable to carry out the calibration with the rotor turning rather than with the rotor stationary. For this purpose, the blade angles should not be exactly in the vane position, but in a slightly pitched condition, in the range of up to 20°, up to 10°, etc. The blade root bending moments acting in the flapping direction are then reduced by the factor sin(α) if a denotes the blade angle, which can also be referred to as the pitch angle. The blade angle or this relationship can be taken into account in the evaluation calculation.

Up to now, the influence of aerodynamics has been ignored or calibration has not been carried out above a wind speed threshold.

It is now proposed that aerodynamic influences are corrected as well as possible during the adjustment process.

It has been recognized that in recent years the rotor blades of new turbine types have become lighter due to material savings, i.e., the ratio of weight forces and aerodynamic forces has tended to shift towards aerodynamic forces. The increased influence of aerodynamic forces can be taken into account by the proposed method.

Furthermore, it has been recognized that a decreasing rotor blade stiffness has led to larger inclination angles of the nacelle, i.e., larger axial inclinations of the rotor axis, in order to enable sufficient tower clearance of the rotor blades. This is illustrated in FIG. 3.

It has been recognized that the inclination angle, which can therefore be referred to synonymously as the angle of inclination of the rotor axis, causes a flow from the front to lead to lift forces, as can be seen in the comparison between FIGS. 4A and 4B, in each of which a profile section of a rotor blade in the vane position is shown, which points laterally away from the wind power installation.

This effect occurs equally in the “9 o'clock position” and the “3 o'clock position” and acts upwards in both cases, i.e., against the direction of the weight force. The tilt angle, i.e., the axial inclination, therefore leads to a part of the blade weight being compensated by the lift and no longer contributing to the blade root bending moment and therefore cannot be detected at the measuring point close to the blade root. An adjustment procedure can interpret this as an insensitive measuring point and determine a higher amplification factor, which is then used to multiply subsequent measured values.

It has been recognized that the strength of the lift force and the previously described effect on the amplification factor increases quadratically with the incident-flow velocity.

As the incident-flow velocity is only measured at certain points, it makes sense to use the rotor speed as an indicator for the average incident-flow velocity. Since an adjustment without generator torque and with a constant pitch angle always results in the same speed, the described effect will also increase quadratically with the rotor speed. It is therefore suggested that a correction be made which is calculated from the squared rotor speed and a weighting factor. The weighting factor can be determined experimentally or by means of simulations. Instead of the rotor speed, however, the wind speed measurement itself can also be used, i.e., the wind speed is then used for the calculation instead of the rotor speed.

Two different modeling approaches appear conceivable. Either an additive error can be modeled, in which the correlation

$$measured value = measurement amplification \times ( weight force - aerodynamic lift force )$$

$$i . = meansurement amplification \times ( weight force - weighting factor \times speed \hat{} 2 )$$

is assumed, and the measurement amplification is then calculated according to the formula

$$measurement amplification = measure value \div ( weight force - weighting factor \times speed \hat{} 2 ) .$$

The measured value can be referred to synonymously as the sensor value. The measurement amplification can be referred to synonymously as the conversion factor. This previous formula can therefore also be written as U=S/(G−W₁*n²).

A multiplicative error can also be modeled,

$$measured value = measurement amplification \times weight force \times ( 1 - weighting factor \times speed \hat{} 2 ) ,$$

wherein the correction is then made using the formula

$$measured amplification = measurement value \div weight force \div ( 1 - weighting factor \times speed \hat{} 2 ) ,$$

Here too, the measured value can be referred to synonymously as the sensor value and the measurement amplification can be referred to synonymously as the conversion factor. This previous formula can therefore also be written as U=S/(G*(1−W₂*n²)).

1. A method for calibrating a measuring device for measuring a load of a rotor blade of a wind power installation, wherein the wind power installation has a rotor with a rotor axis and a plurality of rotor blades adjustable in their blade angle, the method comprising:
for each rotor blade of the plurality of rotor blades,
recording a sensor value of a load sensor,
determining at least one conversion factor for converting the sensor value into a load value acting on the rotor blade in an area of a blade root of the rotor blade, wherein
the conversion factor is determined from a relationship between the sensor value and a comparative force acting on the rotor blade,
the comparative force is determined as a function of a weight force acting on the rotor blade, and
a function of a correction component that takes into account a deviation between the comparative force and the weight force.

2. The method as claimed in claim 1, wherein
the correction component
is determined as a function of at least one of an aerodynamic force on the rotor blade or
an axial inclination of the rotor axis.

3. The method as claimed in claim 1, wherein
calibrating the measuring device is carried out completely or partially during operation of the wind power installation, or is carried out in a protective mode in which the rotor blades are in a protective mode position that deviates by a maximum of 30° from a vane position.

4. The method as claimed in claim 1, wherein calibrating the measuring device is carried out at least partially at high wind speeds, above a nominal wind speed, or at least partially at a horizontal position of the rotor blade or at a 9 o'clock or 3 o'clock position of the rotor in relation to the rotor blade.

5. The method as claimed in claim 1, wherein at least one of:
the correction component is determined by a simulation and/or by comparative measurements,
the correction component factors out a systematic influence that changes an effect of the weight force on the rotor blade, or
the correction component is determined as a function of the blade angle of the rotor blade.

6. The method as claimed in claim 1, wherein
recording the sensor value determining the at least one conversion factor is repeated at, at least one of a same wind speed, a same rotor speed, or a same rotor blade angle, and
an overall conversion factor is determined as a mean value of individual conversion factors determined for each repetition.

7. The method as claimed in claim 1, wherein
recording the sensor value and determining the at least one conversion factor is repeated at regular intervals, the regular intervals including one of 1-7 days, 1-4 weeks, or 1-12 months, and
individual conversion factors determined for each repetition are stored together with respective associated boundary conditions.

8. The method as claimed in claim 1, wherein
a rotor speed is included quadratically in the correction component together with a weighting factor.

9. The method as claimed in claim 1, wherein
the correction component is determined as an additive correction value, so that the at least one conversion factor, U, is determined from a sum of the weight force and the correction component according to equation:
$$U = S / ( G - {W}_{1} * {n}^{2} )$$
with
S: sensor value,
G: weight force acting on the rotor blade
W₁: first weighting factor for additive correction value and
n: rotor speed or wind speed, wherein
W₁*n² represents an additive correction value and (G-W₁*n²) represents the comparative force.

10. A wind power installation configured to calibrate a measuring device for measuring a load of a rotor blade of the wind power installation, wherein the wind power installation has a rotor with a rotor axis and a plurality of rotor blades with an adjustable blade angle, wherein the wind power installation is configured to:
for one rotor blade at a time,
record a sensor value of a load sensor,
determine at least one conversion factor for converting the sensor value into a load value acting on the rotor blade in an area of a blade root of the rotor blade, wherein
the conversion factor is determined from a relationship between the sensor value and a comparative force acting on the rotor blade,
the comparative force is determined as a function of a weight force acting on the rotor blade, and
a function of a correction component that takes into account a deviation between the comparative force and the weight force.

11. The wind power installation as claimed in claim 10, wherein
the wind power installation has a control device configured to control the wind power installation.

12. The method as claimed in claim 2, wherein the correction component is determined as a function of an aerodynamic, upward force that acts on the rotor blade due to the axial inclination of the rotor from the wind.

13. The method as claimed in claim 1, wherein calibrating the measuring device is performed without generator torque.

14. The method as claimed in claim 1, where the correction component is determined as a multiplicative correction value, so that the at least one conversion factor, U, is determined from a product of the weight force and the correction component according to equation:
$$U = S / ( G * ( 1 - {W}_{2} * {n}^{2} ) )$$
with
S: sensor value,
G: weight force acting on the rotor blade
W₂: second weighting factor for multiplicative correction value and
n: rotor speed or wind speed, wherein
1−W₂*n² represents the multiplicative correction value and G*(1−W₂*n²) represents the comparative force.

15. The wind power installation as claimed in claim 10, wherein the correction component is determined as a function of at least one of an aerodynamic force on the rotor blade or an axial inclination of the rotor axis.

16. The wind power installation as claimed in claim 10, wherein the wind power installation is configured to calibrate the measuring device completely or partially during operation of the wind power installation, or in a protective mode in which the rotor blades are in a protective mode position that deviates by a maximum of 30° from a vane position.

17. The wind power installation as claimed in claim 10, wherein the wind power installation is configured to calibrate the measuring device,
at least partially at high wind speeds, above a nominal wind speed, or
at least partially at a horizontal position of the rotor blade or at a 9 o'clock or 3 o'clock position of the rotor in relation to the rotor blade.

18. The wind power installation as claimed in claim 10, wherein at least one of:
the correction component is determined by a simulation and/or by comparative measurements,
the correction component factors out a systematic influence that changes an effect of the weight force on the rotor blade, or
the correction component is determined as a function of the blade angle of the rotor blade.

19. The wind power installation as claimed in claim 10, wherein the wind power installation is configured to:
repeat recording the sensor value and determining the at least one conversion factor at, at least one of a same wind speed, a same rotor speed, or a same rotor blade angle, and
determine an overall conversion factor as a mean value of individual conversion factors determined for each repetition.

20. The wind power installation as claimed in claim 10, wherein the wind power installation is configured to:
repeat recording the sensor value and determining the at least one conversion factor at regular intervals, the regular intervals including one of 1-7 days, 1-4 weeks, or 1-12 months, and
store individual conversion factors determined for each repetition together with respective associated boundary conditions.
